(19) United States
(12) Patent Application Publication
(10) Pub. No.: US 2015/0278915 A1
(43) Pub. Date: Oct. 1, 2015

(54) RECOMMENDATION SYSTEM FOR NON-FUNGIBLE ASSETS

(71) Applicant: Auction.com, LLC, Irvine, CA (US)

(72) Inventors: Harshal Dedhia, Mountain View, CA (US); Nicholas Dearden, Los Gatos, CA (US); William Wolf Rendall, San Francisco, CA (US); Matthew Lock, San Francisco, CA (US); Sheridan Hitchens, Irvine, CA (US)

(21) Appl. No.: 14/670,098

(22) Filed: Mar. 26, 2015

Related U.S. Application Data
(60) Provisional application No. 61/967,839, filed on Mar. 26, 2014.

(51) Int. Cl. G06Q 30/06; G06F 17/30

(52) U.S. Cl. CPC G06Q 30/0631; G06F 17/30867; G06F 17/30241; G06Q 50/165

(57) ABSTRACT

A recommendation system and method for recommending non-fungible assets to individuals based on a determined interest of such users for assets and their respective characteristics.

### RELATED APPLICATIONS

This application claims priority to Provisional U.S. Patent Application No. 61/967,839, filed Mar. 26, 2014; the aforementioned priority application being incorporated by reference in its entirety.

### TECHNICAL FIELD

Examples described herein pertain generally to a recommendation system for non-fungible assets, such as real-property assets.

### BACKGROUND

A variety of auction forums exist that enable users to transact for various kinds of items, such as collectibles, electronics, and other goods or services. Recommendation engines also exist for numerous applications, including content delivery and for purchase of goods and products. Typical approaches for the application of recommendation engines include (i) linking users by preferences or choices, then making recommendations on the assumption that individuals with similar tastes can act as a source of recommendation for one another, or (ii) identify similar assets for recommendation (e.g., if a user likes products of a particular color, recommend another product of same color, etc.). Such recommendation engines have varying degrees of effectiveness.

### BRIEF DESCRIPTION OF THE DRAWINGS

FIG. 1 illustrates a recommendation system for real-property assets, according to an embodiment.

FIG. 2A illustrates an example method for recommending assets from an asset pool database by quantitatively determining user interest for a relevant type of assets.

FIG. 2B illustrates an example method for recommending real-property assets to users.

FIG. 3 illustrates an example method optimizing the recommendation of real-property assets to a group of users.

FIG. 4 is an example of a set of recommendations for real-property assets, as provided by examples described herein.

FIG. 5 is a block diagram that illustrates a computer system upon which examples described herein may be implemented.

### DETAILED DESCRIPTION

Examples described herein pertain generally to a recommendation system for non-fungible assets, such as real-property assets. In some embodiments, a recommendation system and method are provided for recommending non-fungible assets to individuals based on a determined interest of such users for assets and their respective characteristics. Still further, some examples provide for implementing optimization processes to further select what real-property assets are recommended to individual users based on an available pool of real-property assets.

Some examples described herein include a system and method for recommending assets from a database of non-fungible assets. According to some examples, a set of characteristics are determined for an asset type of the asset database, where each characteristic is defined to correlate to a range of possible values. A numeric model is determined for each asset in the database. The numeric model can be based on a value of each characteristic in the set of characteristics for that asset. The performance of activities by one or more users of a group are detected, when that user's activities are indicative of that user's interest in a corresponding set of one or more assets. For each user in the group, a value is determined for each characteristic of each asset in the corresponding set of assets for that user. An interest model is determined for each user in the group, where the interest model is based on the value of each characteristic of each asset in the set of assets for that user. The interest model of each user is compared with the numeric model of each asset in the database in order to determine a match set of assets for that user. A recommendation can be generated each user in the group based on one or more assets determined in the match set of assets for that user.

The term “fungible” refers to an item or quantity which can be replaced by another item or quantity. Examples of fungible items include a manufactured good, such as provided by a product line, which are often produced in large quantities (e.g., household goods, phone, etc.) Such items are fungible because they have equivalent replacements—for example, if a user makes a purchase of a household good from an online retailer and the item is shipped defective, the user cans simply request a replacement. In some instances, a user may purchase a non-brand but otherwise identical version of a fungible item.

By way of contrast, non-fungible assets (or items) is intended to mean items which have attributes which have uniqueness or scarcity as compared to other items which are similar or of a same class. Examples of non-fungible assets include real-property assets, fine art items and other collectibles. While numerous examples are described below in context of real-property assets, embodiments such as described below can be applied to other kinds of non-fungible assets.

The term “recommendation” includes any form of communication, whether direct (e.g., addressed to the person receiving the communication) or indirect (e.g., shown to the user in other context, such as through advertisement). For example, a recommendation can include a message, a notification, a portion of a search result, and/or web content provided as a portion of a web page.

With regard to non-fungible items, examples described herein recognize that that available inventory can limit recommendations which use conventional approaches such as similarity comparison amongst assets. For example, the size, diversity and rate of change of the inventory can hinder effective similarity comparisons, at least at the granularity needed for recommendations to consistently effective. Moreover, non-fungible items are relatively unique, and non-fungible assets which share attributes can be scarce, particularly in comparison to the size of the people who may want to receive recommendations. Moreover, attributes which make one non-fungible asset appealing to one person may not be the reason why another user finds the non-fungible asset appealing, yet both individuals may find the asset appealing.

Online forums (e.g., online auctions and markets) exist which enable transactions for, or otherwise provide access to, non-fungible items. These forums typically expend dedicated hardware and/or software resources for conducting and maintaining the forum. Generally, an inventory of non-fungible items is associated with such forums. For example, a real-estate forum (e.g., auction website) may host auctions for different kinds of real-estate items (e.g., residential homes, commercial buildings, notes, etc.). A computing resource such as a database (or combination of databases) can maintain data (e.g., records) for individual assets. Embodiments recognize that as a general goal, the more inventory is disposed through transactions, the more capacity the memory system has to carry a greater number of assets for transactions. The recommendations which are generated from a recommendation engine can be based on records from the database (or other computing resource) of the online forum. A recommendation engine can facilitate an online forum by bringing interest to potential buyers for assets which are listed with the database. In this way, a recommendation engine can provide a technical effect of utilizing the database (or other computing resource) in a more efficient manner-more records (for items being transacted) can disposed successfully (e.g. sold) when recommendations are in place, meaning less memory is needed to enable transaction for more items.

In this regard, online forums in which non-fungible items are provided for transaction have challenges which are unique to the online environment. While a recommendation engine can increase interest and participation to such online forums and thus facilitate turn-over of items which are actively listed for transaction (thereby more efficiently utilizing the database or memory), simply increasing traffic in this manner is not enough to optimize or generate efficient access of asset listings by a population of potential buyers. Embodiments recognize that when a recommendation engine employs similarity algorithms to recommend non-fungible items, a relatively small number of assets can be over-recommended. Likewise, when a recommendation system employs techniques to match users by preference similarities in order to recommend items that matching users liked to other matching users, the resulting recommendations also focus on a relatively small number of attributes. Thus, examples recognize that in the context of non-fungible assets such as real-estate, conventional recommendation processes tend to drive interest to only a subset of the asset pool and ignore a larger portion of the asset pool (even though items in the larger asset pool would have more interest to select people). Under conventional recommendation processes, many (if not most) of the items in the asset pool would become stale, and records corresponding to those assets would occupy memory resources for longer stretches of time, while other portions of the database system would experience disproportionately heavy loads from over recommended assets, thereby reducing the overall efficiency of the database, among other shortcomings.

In contrast to such conventional approaches, examples described herein provide for a recommendation system that is interest-based, meaning recommendations provided for persons are based on observed or known interests of that individual. By being interest based for individuals, examples described herein recognize that a greater percentage of an asset pool can be identified as being of potential interest to the user. For example, if the user is determined to be interested in large homes from a particular area, when inventory is scarce, the recommendation engine may identify recommendations which show similar sized homes in alternative locations, or smaller homes in the same location of interest. The determination of the interest profile can be based on both active and passive monitoring of the user's activities relating to the non-fungible asset. As described with real-estate, the person's interest can be modeled based at least in part on one or more of the following: (i) online activities, such as browsing and viewing listings for homes, (ii) bidding activity, such as the user placing a bid in an online forum (e.g., auction), (iii) viewing and/or searching, such as when the user views listings from a particular zip code or makes an inquiry to a realtor, (iv) non-bidding auction activity (e.g., user registers for an auction, reviews an auction item before or during auction, etc.), Still further, in the case of real-estate, the interest model for a user can be based at least in part on offline activities of the person. For example, in the case of real-estate, the mobile computing device of the user can be monitored to determine the current location of the individual, their city of residence, and/or offline property listings (e.g., person visits open house). Still further, demographic information can also be obtained, including information about a current residence of the user and/or past transactions. The asset identified by such online activities can be scanned for a variety of different attributes in order to develop a user-specific interest model.

For purpose of described examples, the term “user” or “users” is intended to mean a purchasing entity. While the term “user” can refer to person, the term “user” can also refer to a legal entity, such as a corporation or partnership.

As used herein, an “real-property asset” can refer to different types of real estate property, such as a single family residence, a condominium, an apartment, a commercial property, a parcel of land, or a note (e.g., mortgage).

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples of the invention can be carried and/or executed. In particular, the numerous machines shown with examples of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Description

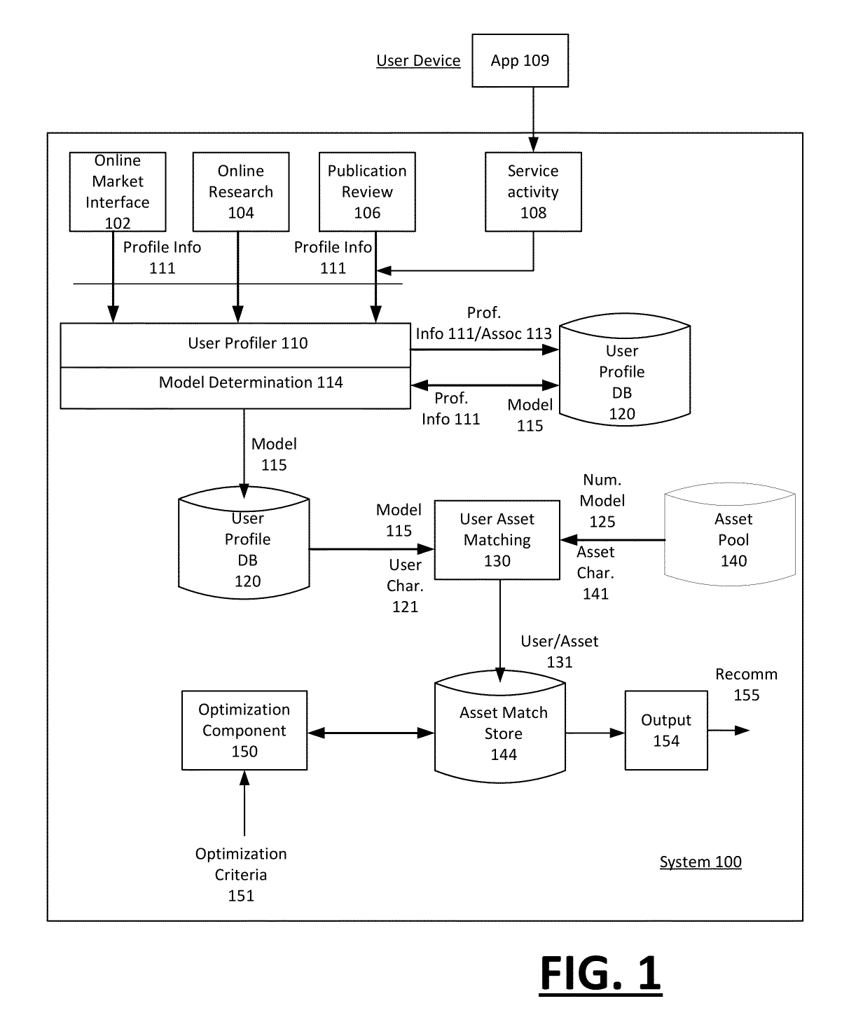

FIG. 1 illustrates a recommendation system for generating recommendations of non-fungible assets for a given population of persons (also termed “users”), according to one or more embodiments. A system 100 such as described by an example of FIG. 1 can be implemented in a variety of computing environments. For example, system 100 can be implemented as part of an online market system or environment, such as an online auction, or can be implemented as a network service that augments or facilitates an online market place. Accordingly, system 100 can be implemented as a network service, through a combination of servers and/or other network enabled computing devices. In variations, system 100 can be implemented on other computing platforms, including stand-alone systems. Thus, in some variations, system 100 can operate on a product or service that is maintained on a single computing device or storage device.

With reference to FIG. 1, system 100 includes a user profiler 110, a user-asset matching component 130, and an asset distribution and optimization component 150 (“optimization component 150”). The user profiler 110 operates to obtain profile information for individual users based on various activities of the individual users. The profile information 111 can be indicative of the user's preference or taste for the non-fungible asset. An example of FIG. 1 recognizes that an online system can monitor user activity in a variety different context so as to identify actions which are indicative of user interest or preference for non-fungible assets. In this respect, the online system has advantages over conventional offline practices, such as, for example, in practices where user preference or taste is identified by asking the user direct questions (e.g., “How many bedrooms are you looking for in a house?”). In contrast, an online system of FIG. 1 can monitor for user actions which indirectly indicate the user interest. For example, the user is not asked directly what type of home he or she is interested in, but user interest can be inferred when they perform specific activities, such as described below. In this regard, the online medium provides a mechanism by which input signals for the recommendation engine are both non-intrusive and probative, in that numerous activities of the user can be detected and utilized for purpose of determining recommendations. The type of profile information 111 that can be obtained from monitoring the online activities of users can also identify or otherwise indicate the interests of those individuals in terms of a particular kind of non-fungible asset (e.g., real-property assets that the particular user may wish to purchase).

According to one aspect, the monitors 102, 104, 106 can operate in a variety of computing mediums in order to detect relevant activity of individual users. In some implementations, multiple instances of monitors 102, 104, 106 can be implemented to obtain profile information 111 from online sessions and/or computing devices operated by individuals for whom activities are detected and analyzed. The link between users and profile information 111 can be made through, for example, use of cookie identifiers (e.g., for activities detected through a given user's browser), machine identifiers (e.g., for activities detected through a user's computing device), or login sessions (e.g., for activities detected for a network service or website in which the user has an account or login).

In one example, the user profiler 110 obtains profile information 111 from an online market monitor 102. The online market monitor 102 can correspond to a programmatic interface to an online market (e.g., such as hosted by a website) which operates to detect certain kinds or aspects of user activity. In particular, the online market monitor 102 can correspond to an auction forum, where real-property assets (or other kinds of non-fungible assets) are provided for auction and sale. An example of FIG. 1 recognizes that activities related to auction forums are often more deliberate (and thus more probative of intent) than more casual activity such as browsing or searching. Additionally, auctions represent are a common marketplace for transactions of non-fungible assets. The types of activities that can be monitored from a user's participation with an auction forum can include, for example, (i) assets (e.g., a real-property asset) that a particular user purchased in auction, (ii) an auction for an asset in which the user placed a bid on, (iii) an auction for an asset that a user registered for as a bidder, and/or (iv) auctions for real-property assets that the user showed interest in, through for example, searching and browsing. The user profiler 110 can associate activity as determined by the online market monitor 102 with the particular user based on, for example, registration information for the online marketplace (e.g., an auction may require the user to register before bidding), and/or cookie information which can identify some online market activities of the user with the user identifier.

While the online market monitor 102 is described with specific reference to an auction forum, other types of online marketplaces can also be implemented in terms of determining profile information for users. Examples of such other forums include online markets and listing services where real-property assets, collectibles, and other non-fungible assets are advertised and made available for sale.

As another example, the user profiler 110 can operate to obtain aggregate profile information 111 from user activity related to online research. By way of example, user activity related to research can include a user's submission of search term for search engine s (e.g., search engine for real-property listings) and/or search results obtained by the user from a search engine.

As another example, the user profiler 110 can also receive information from a publication monitor 106, which interfaces with one or more online publications in order to determine user interest in real-property assets. In one implementation, a newsletter can be distributed to a group of users by, for example email. In variations, an online publication can be provided in the form of a webpage. The publication monitor 106 can monitor, for example, a user interaction with links to real-property listings that are embedded in the publication. The interaction with the links can include (i) user selection of a link, (ii) a user copying/pasting a link or bookmarking a link, and/or (iii) the user hovering over a link (or hovering for a period of time that exceeds a specific threshold). The monitored interaction can indicate an interest level of a user with a given listing. In one implementation, the online publication can include active links, which include data elements that identify when certain activities are performed that are indicative of user interest. In particular, a real-property asset can be associated with a link (e.g., a listing for a real-property asset can be published in the form of a link), and a user can select the link to view information about the real-property asset that is available for sale. In variations, the links can be encoded with data that identifies when a user hovers over a link, and/or selects a particular link. Other markers of interest can also be identified, such as the time duration in which the user views a particular page where a real-property asset is displayed.

Information obtained from the links of the newsletter can be communicated to the user profiler 110, and associated with a given user. For example, the online publication can be emailed to users, and the active links provided in the publication can be associated with the user identifier. When perform activities that are indicative of interest, the publication monitor 106 records the particular user and the activity performed. This information is then obtained by the user profiler 110.

In some variations, the monitors 102, 104, 106 can include components which operate on a user terminal or as part of a network service and interface with third-party domains and search engines. For example, in the context of real-property listings, system 100 may store a cookie (or cause a cookie to be stored) on a user's system, and subsequent browsing activity of the user can result in the cookie providing access to records which identify any one or more of (i) a web page on which a listing (or set of listings) for real-property assets appears, or (ii) a listing on a web page in which multiple listings is provided for a given real-property asset.

As an addition or alternative to identifying specific real-property assets, some activities can also identify general information about real-property assets which may be of interest to a user. For example, the monitor 104 can interface with a third-party search engine (such as provided on a real-property listing site) in order to determine a general but relevant search term that the user submitted in connection with a search for a particular kind of non-fungible asset (e.g., “home prices in Florida”). As an addition or alternative, the monitors 102, 104, 106 can be implemented with network resources that require user login, and network and/or client resources. The monitors 102, 104, 106 can include processes which execute with such network resources to collect information relevant to real-property listings (e.g., bidding, searching, etc.) or other non-fungible assets. As an alternative or variation, the monitors 102, 104, 106 can execute or otherwise interface with a website in order to determine information about individual assets (e.g., real-property assets) that were viewed in different context (e.g., real-property listing versus general search). The monitors 102, 104, 106 can also associate cookies or other identifiers with user profiles, and further communicate the online activity of the particular individual so that profile information is associated or otherwise linked with the individual's identifier. The correlation between profile information 111 and individual users whom performed activities resulting in the profile information 111 can thus be made at the time to information is gathered or collected. In variations, however, the user profiler 110 can include logic or other resources to correlate profile information 111 with users after the profile information is collected.

In some variations, offline (or real-world activity) of a user is monitored to determine user actions which indicate interest for a particular type of asset. For example, individuals now carry mobile computing devices which include Global Positioning System (GPS) resources to identify the location of the mobile computing device at a particular instant. Such mobile computing devices can also run applications which can communicate with system 100 automatically or through background processes. Service activity 108 provides an example of an interface for detecting real-world user activity (e.g., user going to open house) which indicate user preference oe taste for real-property assets. In one implementation, service interface 108 can record profile information 111 based on physical activities recorded by the user operating a mobile computing device. For example, a user can run an application 109 on a mobile computing device to record activities such as the user visiting an open house or touring a neighborhood. The activities can be recorded passively (e.g., the user launches an application on a mobile device and then does nothing else) are through direct user interaction (e.g., the user provides input identifying an open house that the user is looking at). In some implementations, the application 109 can interface with local GPS resources of the mobile computing device to record position information of the user. The application 109 (or system 100) can map the position information to a street address and further to known information about the real-property located at a particular location. Thus, for example, a user can run the application and then visit one or more open houses. The application 109 can also record position information, and processes of the application and/or system 100 can reference the position information to street addresses in order to identify a real-property listing or asset.

The profile information 111 can be based on different signals or input. For example, the profile information 111 can identify specific assets (e.g., a particular real-property asset of interest), a content item depicting an asset (e.g., a listing or advertisement for the sale of a real-property asset), or general information (e.g., search term or general characterization (e.g., multistory single-family home) determined from user input or activity). The user profiler 110 can also utilize other off-line sources, such as information about what real-property assets a particular user owns (e.g., a home or vacation home of the user). Still further, the user profiler 110 can also obtain demographic information for the user, including the geographic location of the user (e.g., where the user actually lives), and are the income of the user (to determine what the particular user can afford).

When profile information 111 identifies specific assets, the assets can be analyzed for predetermined attributes as part of a process for developing an interest model for individual users of system 100. For example, the profile information 111 can be based on online real-estate listings (e.g., a listing on a webpage) which can be programmatically parsed for information which can correlate to values of the predetermined characteristics. As an addition or alternative, system 100 can utilize the determined identifier of the real-property asset (e.g., street address) in order to programmatically interface with and access government records for the real-property asset. The use of additional sources such as government records can verify and/or augment information correlating to values of characteristics of the real-property asset of interest.

For real-property assets, the predefined characteristics used in determining recommendations 155 include, for example, geography (e.g., city, state, county), location within the geography (e.g., neighborhood), property type (e.g., single-family home, apartment), price range, and dwelling/parcel characteristics such as number of bedrooms, lot size, and number bathrooms. As an additional or alternative, other characteristics of real-property assets can include, for example, the type of title provided (e.g., quick claim), the occupancy status, and/or whether financing is available for the real-property asset. The user profiler 110 can, for example, tabulate the real-property assets that have been identified as being of interest to a particular user by category, subcategory, in characteristics.

In an example of FIG. 1, the user profiler 110 stores user profile information 111 in the user profile database 120 (shown as separate instance in an example of FIG. 1). The profile information 111 can include an association 113 with a corresponding user (whom can be identified anonymously or otherwise, depending on user preference). The profile information 111 for individual users can be monitored and updated over a duration that extends, for example, to several online sessions. In this way, the profile information of individual users can be developed and refined over time.

A model determination component 114 can access the profile information 111 in order to determine an interest model 115 for the user. According to an aspect, the user profiler 110 can implement a process for determining interest models 115 for individual users based on the profile information 111 associated with the individual users. The interest model 115 refers to a mufti-dimensional user-specific model which quantitatively defines a perceived preference of a user for individual attributes or characteristics of a non-fungible item. The interest model 115 can be based on a set of characteristics or attributes which are predefined for the type of non-fungible asset being considered for recommendations. In some examples, the characteristics or attributes of interest model can be normalized in value (e.g., between zero and 0 and 1), and some characteristics or attributes can be weighted as compared the other characteristics. In particular, a determination to weight some characteristics or attributes can be based on a pre-defined schema, such as the type of asset (e.g., real-property asset), the sub-type of asset (e.g., residential property versus commercial property) or the value of specific characteristics. As an additional or alternative, the model determination component 114 can weight some characteristics or attributes over others based on a user interest or user specific parameter (e.g., users who investors may be more interested in distressed or commercial properties as opposed to luxury homes).

In an example of FIG. 1, the model determination component 114 determines interest models 115 that have sufficient dimensionality and depth to enable identification of a greater number of assets that are of interest from the database pool of assets 140 at a given instance of time, as compared to conventional approaches which utilize, for example, similarity determinations as between known asset of interest and/or tracking amongst users who match in preference. In one implementation the user profiler 110 can determine an interest model 115 for a specific user which is quantitatively descriptive of the user's interest for real-property assets. The characteristics or attributes used to define the interest model 115 can also be defined by numeric range, and more specifically, as quantities which are normalized (e.g., between 0 and 1). Based on the predefined characteristics, the interest model 115 can populate a subset of the characteristics with a numerical value that is within the defined and normalized range. In some implementations, the characteristics can be normalized so as to be quantified as ratios or whole numbers.

The following examples illustrate how interest models 115 can be determined to quantify a given user's interest in a non-fungible asset, such as a real-property asset. By way of example, predefined parameters can reflect the characteristics or attributes of (i) title type and (ii) availability of financing, and the values assigned to these parameters can be expressed as a binary (e.g., “0” or “1”) to indicate one of two (or a limited number of) possible values for the parameters. Additionally, a predefined parameter can represent the number of bedrooms, and this parameter can be reflected by a determined value that is a whole number. Other parameters can represent characteristics or attributes such as price range and lot/dwelling size. The interest model 115 can normalize the values for parameters that represent the price range and lot/dwelling size using a parameter-specific definition. For example, each of the price range and lot/dwelling size can be represented by a number between “0” (representing a low number for the parameter) or “1” (representing a large number for the parameter). In this way, the interest model 115 quantifies the relative interest the user has in characteristics of a real-property asset.

In some variations, the interest model 115 can incorporate weights (e.g., coefficients or ratios applied to normalized values) based on defined or known relationships or conditions. For example, if the user is known to be interested in real-property assets that range between three and five bedrooms, then the parameter correlating to the number of bedrooms can be weighted to be less significant, since the number of bedrooms may not be as significant of characteristic to the user as dwelling size. Likewise, other parameters can be known to be of less interest to users as a whole. For example, title type may not be of interest to all users. By default, this characteristic can be weighted relatively low and equally for different users, unless the profile information 111 for one user indicates a strong interest in the characteristic. In such cases, the profile information 111 of the user may result in a user specific weight being applied to the parameter. Numerous such considerations can be made and developed over time, either specifically for a given user, or generally to the group of users as a whole and/or by default.

According to some examples, model determination component 114 can store the interest model 115 that is determined for individual users who subscribe to, or are otherwise designated to receive recommendations 155 from the system 100. The interest models 115 can be stored in the user profile database 120. The user profile database 120 can also store correlations between individual users (e.g., using user identifiers corresponding to full names or system identifier such as email addresses) and interest profiles 115. Additionally, user profile database 120 can store or profile information 111 as determined from monitors 102, 104, 106.

The user-asset matching component 130 can access the user profile database 120 in order to pair individual users with assets in a given asset pool. The asset pool database 140 can correspond to one or more databases that identify real-property listings (e.g., real-property assets that are for sale) in a particular environment for which recommendations 155 are to be generated and communicated. By way of example, the asset pool database 140 can correspond to a live database which retains records for an online auction forum, an online asset listing service, or an advertisement inventory for such services. The recommendations 155 which result from the system 100 can identify assets of the asset pool database 140 to individual users in a population of users. The effect of the recommendations 155 is that more activity can be generated from, for example, the online auction or market which utilizes the asset pool database 140.

In one example, system 100 is provided in the context of an online auction forum for non-fungible assets such as real-estate listings. In such case, the asset pool database 140 can refer to those assets which are to be auctioned in an upcoming time frame, or alternatively, to those assets which are currently up for auction. In variations, the asset database 140 can be provided in the context of online real estate listings, which can optionally be transacted off-line or through alternative transaction forums (e.g., through a network transaction). The recommendations 155 that are generated for users of assets identified in the asset pool can thus serve as, for example, marketing mechanisms for promoting, for example, specific auctions or online transactions of real-property (or other non-fungible assets).

In one implementation, the user-asset matching component 130 obtains characteristics of interest 121 for individual users in real-property assets, and then references the identified characteristics of interest 121 to asset characteristics 141 of an asset pool 140. The characteristics of interest 121 can identify characteristics or attributes of the non-fungible asset for which the user has a strong affinity for or against (e.g., the user may want homes in only one neighborhood, or avoid condominiums, etc.) In one implementation, the user-asset matching component 130 scans records of the asset pool database 140 in order to determine the asset characteristics 141 of the available assets which can then be used to match assets to users based on characteristics of interest 121 for individual users. By way of example, characteristics of interest 121 and asset characteristics 141 for real-property assets can correspond to geographic location of the real-property asset, specific neighborhood of the real-property asset, the type of property, the dwelling size of the property, the parcel size, the type of title being offered, occupancy status, and/or financing availability.

In another implementation, the user-asset matching component 130 uses the interest model 115 determined for individual users to quantitatively determine those assets in the asset pool database 140 which are either (i) the best match for the user, and/or (ii) a satisfactory match, which can correspond to quantitative comparison that yields a sufficient “match value” that exceeds a defined threshold. In performing such matching, the user-asset matching component 130 can determine scoring models for assets based on the characteristics or attributes of the individual assets. For example, the user asset matching component 130 can implement another instance of model determination component 1 to 14 in order to scan the asset pool database 140 and generate a numerical model that scores each asset the asset pool database 140 based on the predefined characteristics for the asset type. The scoring models can quantitatively represent individual assets using the same or similar parametric definitions and normalized values. For example, the characteristics or attributes of a house can be represented as normalized values (between “0” and “1”) of predefined parameters for the asset or sub-asset type. The numeric model representation of individual assets in the asset pool database 140 can then provide a basis for comparison to interest models 115 which represent interest profiles of individual users.

An output of the user-asset matching component 130 can include, for example, user specific lists of available assets that are of interest to the particular user. In one implementation, the recommendations 155 can be generated from a user specific list of assets 131, which can be determined and stored for the individual users in as asset match store 144. In one implementation, an output component 154 can generate one or more recommendations 155 for individual users based on the asset list 131 for the user. For example, user-asset matching component 130 can determine a set of X (e.g., 5) assets that are of interest to a particular user, and that list of assets can be stored in the asset match store 144. In variations, the output component 154 can generate recommendations 155 based on a real-time comparison of a user's interest model 115 as compared to the numeric model 125 of the individual assets of the asset pool database 140. The recommendations 155 can, for example, be in the form of an email, notification, or displayed content for a webpage (e.g., a dashboard for potential auction user).

In some variation, an optimization component 150 can process the asset lists 131 for the different users in order to optimize distribution of identified assets of the asset database pool 140 based on various criteria. The asset matching store 144 can queue the asset lists 131 of individual users for subsequent optimization and output. In one implementation, optimization component 150 can optimize distribution of recommendations for assets of the asset database pool to one or more of (i) a group of individuals (e.g., two or more), (ii) a combination of groups, and/or (iii) a population of users. The optimization that is performed can be based on one or more criteria 151 that include, for example, timing (e.g., distribute recommendations over an extended time period in order to maximize interest from individuals, groups of individuals or the population of users), revenue (e.g., maximize total revenue from sales of real-property assets in the asset pool 140), and/or number of sales (e.g., maximize number of sales of assets in the asset pool 140).

In one implementation, the optimization component 150 can modify or after asset lists 131 for specific users in accordance with a pre-determined optimization scheme. For example, the asset lists 131 of different users may be filtered so that some assets are removed from the user's list. By way of example, the optimization component 150 can optimize by a global parameter such as number of assets which are recommended, meaning the optimization component operates to maximize the breadth of distribution in the number of assets that are recommended to all users in a given time period. Such an optimization process addresses a problem recognized with an example of FIG. 1, which is: if a common set of real-property assets appear on numerous asset lists 131 of users, only some of those users may ultimately receive the recommendation of that particular real-property asset, as the recommendation for one asset to too many users would be counterproductive in maximizing sales (or revenue). Among other technical effects, the optimization component 150 generates recommendations 155 which in turn, draw interest and activity to further transactions for the recommended assets. The optimized distribution of the recommendations 155 can mean recommendations are spread through the asset pool database 140 so that fewer overlapping or over-recommendations result as compared to, for example recommendations which made from similarity comparisons amongst recommended assets. The result is that system 100 receives more activity affecting more records in the asset pool database 140, resulting in greater number of records in the asset pool database 140 being accessed and utilized for the population of the user.

As an alternative or variation, a priority can be assigned to individual assets in the user's asset list 131. The priority can be based on optimization criteria 151, or other objective (e.g., sale the particular asset). The prioritization of items in the individual asset lists 131 can affect the timing of the recommendations, or alternatively, provide pre-conditions for when recommendations to those users are to eventually be made. For example, when the priority of a given asset in the asset list of one user is de-prioritized, the recommendation for that asset to that user may only be made only if the asset is still available when the time comes for lower priority recommendations to be made to the particular user.

As illustrated by FIG. 1, system 100 can operate to determine recommendations 155 of non-fungible assets (e.g., real-property assets) that may be of interest to individual users. The recommendations 155 drive interest and activity to system 100 and the asset pool database 140, which can be implemented as part of, for example, an online auction or listing service. As a result of recommendations 155, more activity is generated, resulting in greater use and access of the asset pool database 140. Additionally, some variations provide that the recommendations 155 as to real-property assets are optimized for one or more criteria, such as overall sales by number or revenue. The optimization of recommendations 155, in combination with the use of interest model determinations of the recommendations 155, can result in a greater number of assets from the asset pool database 140 receiving recommendations 155. By way of example:

Let A1 (char11, char12 . . . char1n), A2 (char21, char22 . . . char2n) . . . Am (charm1, charm2 . . . charmn) identify assets A1, A2 and Am which are recommended for a user A, and char(1,m)(1,n) are normalized values of a common set of characteristics for the assets.

Let B1 (char11, char12 . . . char1n), B2 (char21, char22 . . . char2n) . . . Bm (charm1, charm2 . . . charmn) identify assets B1, B2 and Bm which are recommended for a user B, and char(1,m)(1,n) are normalized values of a common set of characteristics for the assets.

Under a conventional asset similarity-based recommendation system, the recommended assets for user A (A1, A2 . . . An) would be similar to one another. For example, a Euclidian distance measurement may be used to minimize a feature vector representation of the individual assets A1, A2 and An, so that each asset (A1, A2 . . . An) would be as similar as possible. The asset similarity-based approach inherently clusters recommendations for users because it is common for users to like at least some of the same assets, meaning some assets are of interest to a disproportionately large number of users. In other words, it is common for an inventory of non-fungible assets to include some assets which are heavily liked by many users, meaning a small set of the overall inventory could easily receive a disproportionate number of recommendations (e.g., over-recommended assets) when a conventional similarity-based recommendation system is implemented.

Similarly, under a conventional user similarity-based recommendation system, the recommended assets for user A would be selected based on selections made by the user B. At least some of the assets (A1, A2 . . . An) of user A would then be similar to assets (B1, B2 . . . Bn) of user B, meaning that some of the assets for A and B would overlap. Such a recommendation system could easily result in assets of the asset pool database 140 being over-recommended. Since with non-fungible assets in particular, it is common for certain assets from the pool to be liked by a disproportionate number of users, in which case a small set of assets would be over-recommended to the population as a whole.

In contrast to such conventional approaches, an interest-based recommendation system such as described by FIG. 1 (and other examples provided herein) would identify the assets (A1, A2 . . . An) based on characteristics of numerous assets for which the user has been observed to be interested in. Given a wide range of characteristics and attributes and sufficient observations, the assets (A1, A2 . . . An) of user A would not be selected to minimize dissimilarity or distance. Rather, the assets of user A are selected as being either a best match or a satisfactory match to characteristics or attributes that are known to be of interest to the user. Thus, the interest-based recommendation system can identify a more diverse range of assets for recommendation, particularly since the threshold for what the user appreciates and does not appreciate can be quantified and gauged. Thus, while the interest-based recommendation system 100 of an example of FIG. 1 can identify assets which are determined to be of most interest to the user, the interest-based recommendation system 100 can also identify those assets which are sufficiently of interest, so recommendations of different degrees (e.g., most interested or sufficiently of interest) can be provided to individual users.

Among other technical effects, the variation in the degree of interest for recommendations promotes and facilitates optimization processes for distributing assets of the asset pool database 140 in recommendations. For example, the optimization component 150 can implement optimization routines which promote dissimilar and diverse sets of assets to be selected for recommendations to individual users, so long as the recommended assets meet the threshold criteria of being satisfactory. Additionally, the assets that are the subject of recommendations 155 can be optimized for group or population level optimization criteria, such as optimization criteria to maximize the total number of assets that are recommended to users from the asset pool database 140. Such an approach can increase the throughput and efficiency of the asset pool database 140, resulting in fewer asset records which receive or no activity from the population of users.

Methodology

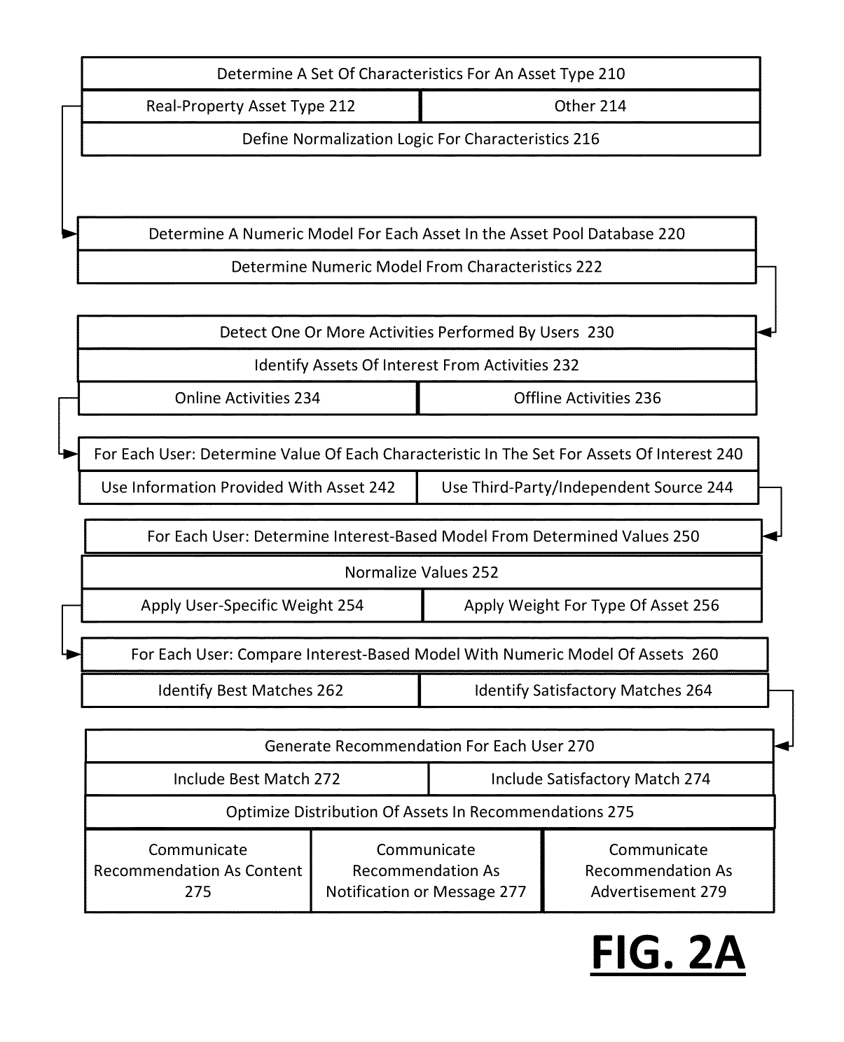

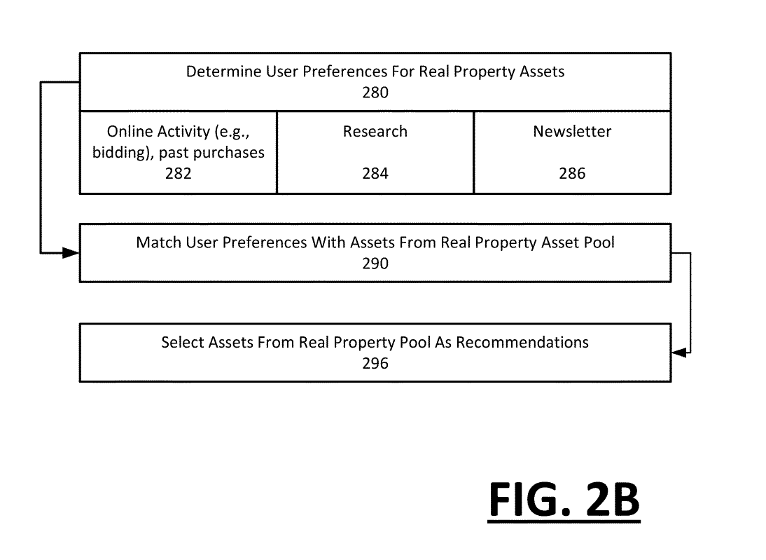

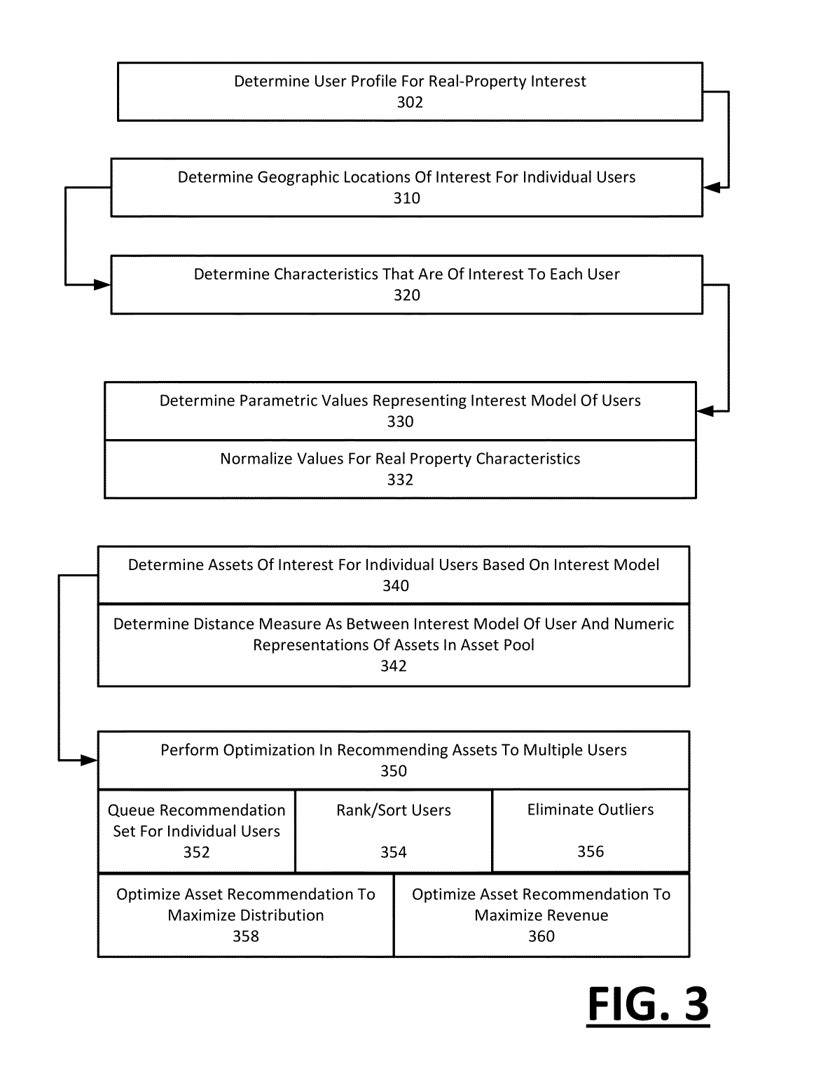

FIG. 2A illustrates an example method for recommending assets from an asset pool database by quantitatively determining user interest for a relevant type of assets. FIG. 2B illustrates an example method for recommending a non-fungible asset to a user based on a user interest determination. FIG. 3 illustrates an example method for optimizing the recommendation of non-fungible assets to a group of users. Example methods such as described by FIG. 2A, FIG. 2B or FIG. 3 can be implemented using, for example, components described with an embodiment of FIG. 1. Accordingly, references made to elements of FIG. 1 are for purposes of illustrating a suitable element or component for performing a step or sub-step being described.

With reference to FIG. 2A, system 100 determines a set of characteristics for an asset type of a given inventory (e.g., asset pool database 140) (210). The asset type can be any non-fungible item, including real-property asset type (212) (as described by numerous examples) or other asset types such as collectibles (214). The set of characteristics can represent a pre-definition for modeling the asset type in a manner that enables quantitative representation of significant or material characteristics of the asset type (e.g., such as characteristics which affect the desirability or value of the asset type). The set of characteristics can be associated with the predefined numerical range, as well as a schema or rule-based mapping logic to normalize determined values of each characteristic (216).

For a real-property asset type, the set of characteristics can include, for example, a property type, a size of the dwelling, a lot size, a number of bedrooms, a number of bathrooms, and/or presence of other features (e.g., connected garage, remodeled, swimming pool, presence of homeowner association and fees, etc.). Other examples of characteristics for the real-property asset type can include a geography where the asset is located (e.g., state and county or city), a neighborhood (e.g., school district or the named development) of the asset, and/or other predefined metrics (e.g., proximity to a desirable location, presence or type of public transit, etc.).

In one implementation, a numeric model is determined for individual assets of the asset pool database (220). The numeric model can be determined from the characteristics of each asset in the asset pool database 140, with information known or provided with the asset identifying a value for each of the asset's characteristics (222). In some implementations, a normalization schema or mapping logic can be implemented to normalize the value of the characteristics which are determined from the individual assets of the asset pool database 140. As described in more detail, the normalization of the values can quantify and structure the individual characteristics of the available assets to enable comparison and matching interest models that define interest levels and preferences of the individual users. By way of example, the values can be normalized to a predefined range, such as from 0 to 1.

The steps and sub-steps described with (210)-(222) are illustrative of a setup phase for implementing an interest-based recommendation system such as described with an example of FIG. 1. As inventory (e.g., assets of the asset pool database 140) are dynamic and in flux, the setup phase can be updated repeatedly and/or periodically. For example, the setup phase for a given asset pool database 140 can be performed on a nightly basis, or alternatively more frequently (e.g., hourly). Accordingly, in some implementations, the setup phase is an independent process which occurs before recommendations or generated for users. In some variations, however, the recommendation system 100 can include intelligence to identify a select portion of assets for which recommendations are likely effective or desirable. For example, the recommendation system 100 can be implemented to provide fresh inventory data for select users based on, for example, desirable traits of such users (e.g., users who have previously viewed or purchased recommended assets). For a select segment of the user population, some variations provide that numeric models for the assets can be calculated in real-time when, for example, recommendations are to be generated based on profile information of those users.

Independent of the setup phase, the recommendation system 100 can operate to determine an interest model for individual users of its user base. According to some embodiments, the interest models of the users are developed by programmatically monitoring or observing user activity, and specifically, activity relating to assets that are of the asset type (e.g., real-property assets) of the asset pool database 140 (230). By way of example, monitors 102, 104, 106 of the user profiler 110 can operate to identify one or more assets which are the subject of the user activity (e.g., listing on which the user views or bids, open house the user visits, etc.) (232). As described with other examples, such activities can include online activities (234), such as user actions performed on an auction site or listing site, as well as offline activities (e.g., tracking a user through GPS to an open house) (236). The assets that are identified for each user from their respective activity can be termed as the assets of interest from which a user's interest model is determined.

In some implementations, other online activity which can be used to determine and refine the interest model of the user include the user's reaction to recommendations which may be generated from the user's interest based model at a prior instance. For example, a user's interaction with a recommendation or set of recommendations can be detected and used for purpose of developing the user's interest model.

For each user, the assets of interest are analyzed to determine values of characteristics, as defined for the asset type (240). The assets of interest can be analyzed using information provided as part of the user activity that identified the asset (242), as well as from information obtained from independent or third-party sources (244). For example, a real-property asset of interest can be identified from the user browsing an online listing, and information provided with the online listing can include street address, dwelling size, lot size and other information. Some information, however, such as type of title or number of bathrooms may need to be obtained from another source, such as from government sources (e.g., county property records) or other websites (e.g., displaying prior sales of a home, showing number of bathrooms, etc.). Accordingly, one or more of the monitors 102, 104, 106 can include processes to access other sources of information (e.g., programmatic interfaces to government web services) in order to complete the determination of the values for some characteristics of individual assets that are of interest to a user.

For each user, the interest model can be determined using values of characteristics for the assets of interests to that user (250). The values of the interest model can also be normalized (252) using, for example, a schema or rule-based mapping logic. By way of example, the values of the interest model can be normalized to be within a predefined range, such as between 0 and 1. In some variations, values for some characteristics can be weighted. The determination of when and which characteristics of the interest model to weight can be based on one or more factors. For example, a user-specific weight can be applied based on information known about the user, such as the propensity of the user to transact (or attempt to transact) for assets having certain characteristics. For example, the user may be known for purchasing condominiums, but have a propensity for viewing larger homes for enjoyment. In such cases, information which is known about the user (e.g., user may actually purchase condominium) may result in the characteristic of property type being weighted for condominium, rather than a larger type of home. As another example, the determination of which parameters to weight can be based on aspects or characteristics of assets which correlate to the user interest-model (256), such as the asset type or sub-asset type (e.g., type of real-property asset). Still further, in some variations, weights can be triggered for some interest models based on values for some characteristics. For example, if the user is interested in a 3-5 bedroom house, the characteristic of dwelling size can be weighted for that user's interest model, so that the number of bedrooms is not as critical for interest determination as the dwelling size.

Still further, the values of the interest-based profile (or its weights) can be affected by the user interaction with assets that are previously recommended to the user from the recommendation system 150. For example, recommendation system 100 can generate a recommended set of assets, of which the user may select to act on only a subset. Those recommended assets which the user acted on can be analyzed for characteristics which can be weighted up. Conversely, the asset(s) which were recommended to the user but not acted on can be analyzed for characteristics which are weighted down. For example, if a recommended asset which the user does not act on includes a particular characteristic which is not shared by recommended assets which the user did act on, then an inference may be made that particular characteristic (or its value) should be weighted down for the user.

For each user, the user's interest model is compared to numerical models of assets in the asset pool database 140 (260). The comparisons can be used to identify both best matches (262) (those assets which have characteristic values which are closest to the user's interest model) and satisfactory matches (264) (those assets which have characteristic values which satisfy a predetermined threshold).

For each user, a set of recommendations can be generated from the comparison performed on the asset pool database 140 using the user's interest model (270). The set of recommendations can include recommendations which include best matches (272) and/or satisfactory matches (274).

In some variations, an optimization process can be used to select which assets are recommended for individual users (275). In some examples such as described with an example of FIG. 1, the determination of whether to include recommendations for best matches or satisfactory matches can be based in part on an optimization process which optimizes distribution of recommendations for assets of the asset pool database 140 based on group or global optimization parameters. The optimization parameters can include, for example, (i) maximize number of assets of the asset pool database 140 which are recommended to users in a given time period, (ii) maximize the total value of the assets which are recommended to the population of users in a given time period, and/or (iii) maximize the number of assets which are recommended, or the total value of assets which are recommended, but only for select users whom are likely to be responsive to recommendations.

Once recommendations are generated, the recommendations can be communicated to users of the population in one or more mediums. By way of example, the recommendations can be communicated as web content (275), as a notification or message (e.g., embedded in e-mail newsletter) (277), as advertisement delivered through an advertisement channel (279) or through other mechanisms (e.g., such as a personalized direct or electronic newsletter).

With reference to FIG. 2B, user preferences are determined for real-property assets (280), which are examples of non-fungible assets. In particular, user preferences are determined in the connection real-property listings, which include real-property assets that are for sale or transaction. As described with an example of FIG. 1, programmatic monitors and/or interfaces can be used to obtain profile information 111 that is indicative of user interest in real-property assets. For example, the profile information 111 can be determined from online activity of the user, particularly as to online markets such as auction forums (282). The online activity can correspond to, for example, the user's bidding activity, past purchases, auction registrations, etc.

As another example, the profile information 111 can be determined from research activity that the user performs in, for example, a network or online environment (284). For example, monitors in the form of cookies or other programmatic components can detect when the user performs online research for real-property assets on real estate listing services or websites. Still further, the profile information 111 can be determined from user activity in connection with newsletters that identify real-property assets, such as by way of links that locate listings for real-property assets (286). For example, newsletters can include links that are emailed or otherwise publish for individual users. User selection or other activity with regard to links can be detected and tabulated. As still another variation, the user profile can be determined from (i) assets they already own, and/or (ii) input the user provides as to their interest. In some variations, user profile information can be obtained from third-party sources, such as online realty companies which monitor user activity in terms of viewing listings or inquiring about listings.

Once the preference of individual users is determined, the user is matched with one or more assets from an asset pool (290). The matching of user to asset pool can be based on the preferences of the user as to specific or predetermined characteristics of real-property assets, versus the presence of those characteristics in individual assets of the asset pool 140. For example, a user's preference for particular property type, geographic location, parcel size, and bedroom number can serve as criteria for identifying matching assets.

In a variation, the interest model 115 can be determined for the user as a quantitative representation of those characteristics of the user prefers. The interest model 115 can be compared against quantitative representations of individual assets in the asset pool database 140 in order to identify matching assets.

A selection process can be implemented to select recommendations for user based on those assets that are deemed to match to the user's preferences (296).

With reference to FIG. 3, various sources of information are analyzed in order to determine a profile for the user (302) in regards to user interest for real-property assets. In one implementation, the user profile is determined from user activity in regards to real-property purchasing activity (e.g., online auction purchases, bidding activity etc.), online research of real-property assets) and/or review of electronic publications (e.g., interaction with links to real-property listings). The user profile can also be determined from external sources, including sources that are external to system 100. For example, a user's existing real-property (e.g., their home) can be analyzed to determine profile information, such as a preferred geographic location or drawing type. Likewise, demographic information pertinent to determining the user's interest in real-property can also be identified (e.g., income level).

The determination of the user profile includes determining geographic locations of interest for each user (310). In one implementation, real-property assets that are identified as being of interests by way of user activity (e.g., online auction bidding, prior purchases, online research, viewing in electronic publications, etc.) are categorized by geographic location. The geographic location can identify general region (e.g., ZIP Code, city, county) and more specific granularity (e.g., neighborhood, specific block). In one implementation, the geographic locations of real-property assets that are of interest to the user are clustered in order to identify one or more geographic zones of interest for that user. For example, a geographic zone of interest can be defined for a user based on (i) identification of a spatial center for the geographic location of each cluster, and (ii) a designated radius from the calculated center. In this way, the geographic region of interest can be determined for each user based on the geographic clustering of real-property assets that have been of interest to that user.

The real-property that is determined to be of interest to the individual user can be processed to identify characteristics that are of interest to each user (320). The real-property of interest can be determined from the user profile, including from what the user currently owns, what the user has purchased through an online form, and/or what the user has shown interest in through online activity (e.g., online bidding, online research, review of electronic publications, etc.). For example, the user profiler 110 can obtain profile information 111 for determining the characteristics that are of interest to each user.

In one implementation, parametric values representing characteristics of real-property assets that are of interest to users are determined and used as a basis to determine an interest model for individual users (330). The interest model of each user can correspond to, for example, a multidimensional representation of values that correlate to characteristics of real-property assets of interest for a given user. The parametric values can represent various characteristics of a real-property asset, including the property type (e.g., single-family home, apartment), price range, number of bedrooms, number bathrooms, dwelling size, parcel size, the type of title being provided for to the transaction (e.g., quick claim), the occupancy status, and/or whether financing is available.

In one implementation, the characteristics can be quantified through one or more normalization processes (332). For example, some characteristics can be quantified by binary numbers (e.g., occupancy can be characterized as “0” and “1”). Other characteristics such as number of bedrooms or bathrooms can be quantified as a whole number (e.g., “2”, “3” or “4”). The price range, parcel size, and/or lot size can be normalized to some range (e.g., such as between “0” and “1”). Likewise, a numeric value can be assigned to the type of title (e.g., between “0” and “1”).

As an addition or variation, the parametric values that represent the characteristics of real-property assets of interest can also be weighted. The waiting can reflect, for example, the interest of the user for particular characteristics. Alternatively, the weighting can reflect default settings based on acquired information about the group of users. By way of example, if the user's bidding activity in an online auction forum consistently reflects the user's interest in a particular type of dwelling (e.g., three bedrooms, two baths), the user profiler 110 can provide that the parametric values for these characteristics are weighted to have more significance for the particular user. Likewise, some parametric values may be weighted negatively to reflect that users generally don't care about the particular parameter (e.g., occupancy status) as compared to other parameters, unless their respective activity (e.g., as determined by the user profiler 110) indicates an interest in that parameter.

The interest model of each user can be used to select real-property assets that are likely of interest to that user from the pool of available assets (340). In one implementation, individual assets in the asset pool are represented by numeric models that quantify characteristics of the real-property asset, using numeric conversion and normalization rules that are the same or similar to that used in determining the respective interest models of the various users. For each user, a distance measure can be determined as between the interest model of that user and a numeric representation of each asset in the available asset pool (342). The assets that are deemed to be of interest for each user can include, for example, the X (e.g., 5) most similar assets (e.g., closest distance measure), or all assets that satisfy some predetermined threshold of proximity based on the calculated distance measures.

According to some embodiments, the assets that are determined to be likely of interest to each user are optimized for purpose of generating recommendations for real-property listings in the context of the group of users (350). With reference to FIG. 1, for example, the optimization component can perform optimization on the user/asset list 131 (e.g., recommendation list). In this way, the optimization process can be implemented in the context of generating recommendations for the group of users, rather than the individual user.

In one implementation, the optimization component 150 queues the recommendation lists (e.g., user/asset list 131) for individual users (352). The queuing process can further optimize recommendations based on timing of delivery, so that the recommendations for property listings are delivered to various users over the course of a duration of time, rather than all at one time. In this way, a given property listing can be recommended for different users at different times, staggering the interest level for the property listing over the given duration. Likewise, an individual user can receive recommendations over a time period, so as to prolong the user's interest and ability to investigate and/or attempt purchase of the real-property asset. The queuing of the recommendations of the property listing can also allow further optimization processes, such as the ranking and sorting of property listings and/or users, as described below.

As addition or alternative, the users of the recommendation system can be ranked, so that recommended property listings (e.g., user/asset list 131) are sorted based on the ranking of the users (354). For example, the optimization component 150 can rank users based on factors such as the likelihood that the individual users will purchase a real-property listing through an associated online forum (e.g., real-property auction), or alternatively, based on a determination of those users which are deemed to be more likely to provide a higher transaction price for a real-property listing in a given online market place (e.g., real-property auction). When a given real-property asset is on the recommendation list of multiple users, the optimization component 150 can use the ranking or sorting of users to determine which users will actually receive the recommendation of the real-property listing, based on factors such as the value of the real-property listing, or the likelihood that the person receiving the recommendation will purchase or bid (e.g., in an auction forum) on the real-property listing. Thus, when users are ranked, real-property assets that are actually recommended to the user can form a subset of the real-property assets that appear on the individual user's recommendation lists (e.g., user/asset list 131).

As another addition or alternative, the optimization component 150 can identify those real-property assets that appear in the recommendation lists of one or more users and which are outliers (356). Outliers can refer to those real-property assets which have a likely transaction outcome. In particular, the real-property assets that are identified as outliers can include those real-property assets that are highly unlikely to sell, and/or those real-property assets that are highly likely to sell, regardless of whether the property is promoted or recommended. For example, if an auction for a real-property asset includes a reserve price that is deemed to be too high, then the property may be deemed as being highly likely to not sell. Likewise, if the real-property asset is put up for auction with a reserve price that is low, then a determination can be made that the real-property asset will likely sell in an auction forum. Thus, for example, the optimization component 150 can analyze the reserve price for real-property listings in an auction forum (e.g., from the asset pool database 140) that appear in the recommendation list for one or more users.

Still further, the optimization component 150 can optimize the real-property assets that are recommended to users from the various recommendation lists determined for the same users, based on optimization criteria that serves a global purpose such as profitability, revenue, etc. The optimization criteria that is selected can thus limit or control what real-property assets are actually recommended to users, based on considerations for maximizing overall sale or throughput of the real-property listings (358) in the asset pool, and/or the overall revenue that can be generated from the assets in the asset pool (360).

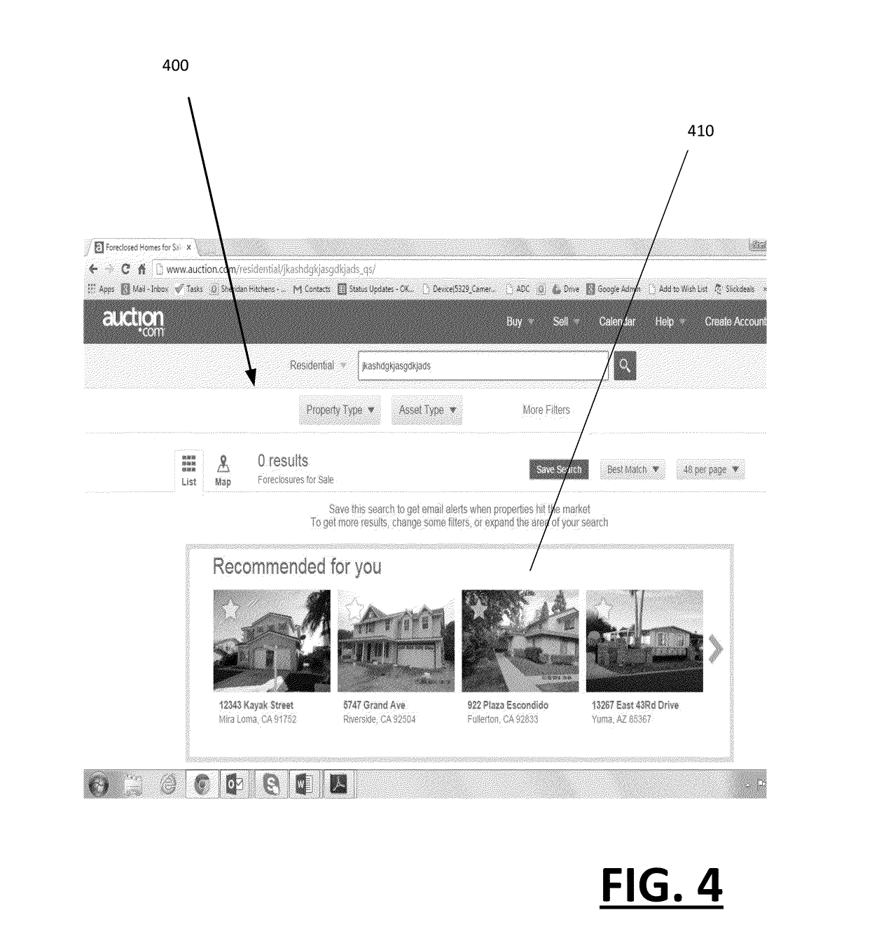

FIG. 4 is an example of a set of recommendations for real-property assets, as provided by examples described herein. In an example of FIG. 4, a recommendation presentation 400 includes multiple listings 410, with each listing 410 identifying a real-property asset that is determined to be of interest to the user. As described with examples of FIGS. 1-3, the listings 410 can be generated to be specific for a user, based on an interest model determined from observing one or more types of user activities. Among other benefits and features, the listings 410 that comprise the recommendation presentation 400 of different users can vary and be user specific. Moreover, the recommendation presentation 400 can display listings 410 that comprise only a subset of the total number of listings in the asset database pool 140 (see e.g., FIG. 1) which are deemed to be of interest to the user.

Moreover, the one or more the listings 410 can correspond to a real-property asset which is of interest to the user, but not necessarily the best (or most of interest) available asset from the asset database pool 100. Rather, one or more of the listings 410 can satisfy a threshold of interest level for the user, so that a greater number of assets from the asset pool database 140 can be distributed (e.g., through recommendations). Thus, for example, recommendation presentation 400 can include listings 410 which are deemed to be of most interest to the user, as well as one or more listings 410 which are of lesser (but satisfactory) interest.

The recommendation presentation 400 can be provided in a variety of mediums, formats and computing environments. In one implementation, recommendation presentation 400 is displayed as a search result when, for example, a user search query for assets of the asset pool database (or other database) generates a null set. As an alternative variation, the recommendation presentation 400 can be displayed in part or whole as advertisement content, or as part of the website on which the asset pool database 140 is made available for transactions.

While an example of FIG. 4 illustrates recommendation presentation 400 as web-based content, in variations, the listings 410 which are recommended to the user can be provided as text through, for example, pushed base notifications (e.g., text-based email or SMS notification). Still further, as another example, recommended listings 410 can be transcribed into audio content and/or mixed with audio video content and displayed to the user as audio and/or visual content (e.g., placement ads on Internet video clips).

Computer System

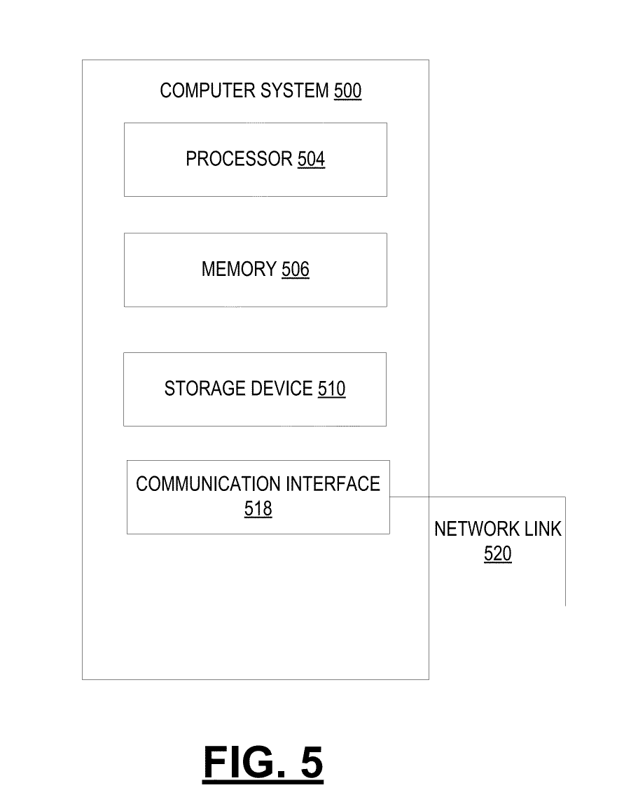

FIG. 5 is a block diagram that illustrates a computer system upon which embodiments described herein may be implemented. For example, in the context of FIG. 1, system 100 may be implemented using one or more servers such as described by FIG. 5. Likewise, a method such as described with FIG. 2 or FIG. 3 can be implemented using, for example, a computer system such as described with FIG. 5.

In an embodiment, computer system 500 includes processor 504, memory 506 (including non-transitory memory), storage device 510, and communication interface 518. Computer system 500 includes at least one processor 504 for processing information. Computer system 500 also includes the main memory 506, such as a random access memory (RAM) or other dynamic storage device, for storing information and instructions to be executed by processor 504. The memory 506 also may be used for storing temporary variables or other intermediate information during execution of instructions to be executed by processor 504. The memory 506 may also include a read only memory (ROM) or other static storage device for storing static information and instructions for processor 504. The storage device 510, such as a magnetic disk or optical disk, is provided for storing information and instructions. The communication interface 518 may enable the computer system 500 to communicate with one or more networks through use of the network link 520 and any one of a number of well-known transfer protocols (e.g., Hypertext Transfer Protocol (HTTP)). Examples of networks include a local area network (LAN), a wide area network (WAN), the Internet, mobile telephone networks, Plain Old Telephone Service (POTS) networks, and wireless data networks (e.g., WiFi and WiMax networks).

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the examples are not limited to those precise descriptions and illustrations. As such, many modifications and variations will be apparent to practitioners. Accordingly, it is contemplated that a particular feature described either individually or as part of an example can be combined with other individually described features, or parts of other examples, even if the other features and examples make no mentioned of the particular feature.

What is claimed is:

1. A method for recommending assets from a database of non-fungible assets, the method being implemented by one or more processors and comprising:
determining a set of characteristics for an asset type, the asset type including the assets from the database, and each characteristic being defined to correlate to a range of possible values;
determining a numeric model for each asset in the database, the numeric model being based on a value of each characteristic in the set of characteristics for that asset;
detecting one or more activities performed by each user of a group, the one or more activities performed by each user of the group being indicative of that user's interest in a corresponding set of one or more assets, each asset in the corresponding set being of the asset type;
for each user in the group,
(i) determining a value of each characteristic in the set of characteristics for each asset in the corresponding set;
(ii) determining an interest model for each user in the group, the interest model being based on the value of each characteristic in the set of characteristics for each asset in the corresponding set;
(iii) comparing the interest model of the user with the numeric model of each asset in the database in order to determine a match set of assets for that user; and
wherein the method further comprises generating a recommendation for each user in the group based on one or more assets determined in the match set of assets for that user.

2. The method of claim 1, wherein each characteristic correlates to a normalized range of possible values.

3. The method of claim 1, wherein comparing the interest model of the user with the numeric model of each asset includes determining each of a best match and a satisfactory match for each user in the group.

4. The method of claim 1, wherein the asset type corresponds to a real-property asset type, and wherein generating the recommendation includes (i) generating a group of recommendations, wherein at least one recommendation in the group is for a corresponding user of the group, and each recommendation of the group specifies at least one real-property asset from the database, and (ii) optimizing a distribution of assets of the database which are recommended based on one or more group optimization parameters.

5. The method of claim 4, wherein the one or more group optimization parameters include at least one of (i) a number of assets from the database which are recommended, or (ii) a value of all the assets from the database which are recommended.

6. The method of claim 1, wherein the asset type corresponds to a real-property asset type, and wherein generating the recommendation includes generating recommendation content which includes one or more recommended listings for each user in the group, the recommendation content being delivered to each user as one or more of (i) web content, (ii) advertisement, or (iii) a message or notification.

7. The method of claim 1, wherein the asset type corresponds to a real-property asset type, and wherein the set of characteristics include multiple characteristics selected from a group consisting of property type, dwelling size, lot size, number of bedrooms, number of bathrooms, geographic location, and neighborhood type.

8. The method of claim 7, wherein the property type includes a determination of occupancy status and a determination of title type.

9. The method of claim 7, wherein each characteristic correlates to a normalized range of possible values between 0 and 1.

10. The method of claim 1, wherein detecting one or more activities performed by each user of the group includes detecting one or more of a browsing or search activity.

11. The method of claim 1, wherein the asset type corresponds to a real-property asset type, detecting one or more activities performed by each user of the group includes detecting a user activity with respect to a website that lists real-property assets for sale.

12. The method of claim 1, wherein the asset type corresponds to a real-property asset type, and wherein detecting one or more activities performed by each user of the group includes detecting a user activity with respect to a website that conducts auctions for real-property assets.

13. The method of claim 12, further comprising detecting each user of the group performing one or more of (i) registering for an auction at the website for a real-property asset, (ii) viewing a listing for the real-property asset prior to or during an auction for the real-property asset, and/or (iii) placing a bid during an auction for the real-property asset.

14. The method of claim 1, wherein detecting one or more activities performed by each user of the group includes detecting a real-world activity of the user.

15. The method of claim 14, wherein detecting the real-world activity includes determining, from position information provided by a global positioning system (GPS) component of a mobile computing device carried by the user, an open house which the user visited.

16. The method of claim 1, wherein the asset type corresponds to a real-property asset type, and wherein detecting one or more activities performed by each user of the group includes detecting a user activity with respect to a website that provides real-property assets, and wherein determining the value of each characteristic in the set of characteristics includes parsing web content for a real-property asset that is determined to be of interest to the user based on the one or more activities performed by the user.

17. The method of claim 16, wherein determining the value of each characteristic in the set of characteristics includes determining, for the real-property asset that is determined to be interest to the user, one or more values for the set of characteristics from a source other than the website.

18. The method of claim 1, wherein the asset type corresponds to a real-property asset type, and wherein determining the interest model includes determining, for a user in the group, to weight the values of one or more characteristics of real-property assets on which the interest model for that user is based.

19. The method of claim 18, wherein determining to weight the values of one or more characteristics is based on a value of one characteristic in the set of characteristics which is shared by a predominant number of real-property assets which are determined to be of interest to the user based on one or more activities of the user.

20. The method of claim 18, wherein determining to weight the values of one or more characteristics is based on a sub-type of the real-property assets that are determined to be of interest to the user based on the one or more activities of the user.
